(19) United States
(12) Patent Application Publication
(10) Pub. No.: US 2020/0132302 A1
(43) Pub. Date: Apr. 30, 2020

(54) FIRE STARTING BULB APPARATUS

(71) Applicant: Damian Maestas, Las Vegas, NM (US)

(72) Inventor: Damian Maestas, Las Vegas, NM (US)

(21) Appl. No.: 16/661,770

(22) Filed: Oct. 23, 2019

Related U.S. Application Data
(60) Provisional application No. 62/749,816, filed on Oct. 24, 2018.

(51) Int. Cl. F23Q 7/22; H05B 3/14

(52) U.S. Cl. CPC F23Q 7/22; H05B 2203/027; H05B 3/141

(57) ABSTRACT

A fire starting bulb apparatus includes a heating element, at least one contact point a bulb. The at least one contact point is operably connected to the heating element. The at least one contact point configured to connect to an energy source for providing energy to the heating element. The bulb having an outer surface and an inner surface. The bulb is configured to receive the heating element so that the heating element provides heat to the inner surface and the outer surface of the bulb when the heating element receives energy from the energy source.

### CROSS REFERENCE TO RELATED APPLICATIONS/INCORPORATION BY REFERENCE STATEMENT

The present patent application claims priority to U.S. Provisional Patent Application U.S. Ser. No. 62/749,816, filed on Oct. 22, 2018, the entire contents of which is hereby expressly incorporated herein by reference.

### FIELD OF THE INVENTION

The present disclosure relates generally to fire starters, and more particularly, not by way of limitation, to an improved ignition device.

### BACKGROUND

A variety of prior art solutions create a flame for ignition purposes, however such solutions lack the optimal functionalities and features to perfectly light a smoking implement.

Electronic cigarette lighters, for instance, require a coil. In prior art solutions, electronic current is passed through the coil, thereby heating it to a temperature to ignite a proximal substance, such as a cigarette. However, prior art coils typically remain inadequately customized for placement into a standard form socket. Moreover, coils typically comprise one or more types of metal. Some forms of heated metal can cause unhealthy vapors, particularly putting those who smoke cigarettes and similar smoking implements at risk. A need, therefore, remains to create a lighting implement that does not create harmful vapors during the lighting process.

A specific context for heated metal lighting relates to vaporizing implements intended for consumption of heated tobacco or other smoking substances. However, a challenge associated with implementing a heated metal into a vaporizing implement, such as a “vape pen” as known by one skilled in the art, is that such implements are typically configured in a custom manner such that the heating element must conform to the specific specifications of the vaporizing implement. In other words, the lack of standardization associated with the heating element of a vaporizing implement causes difficulty associated with the manufacturing and maintenance of such devices.

Previously known lighting mechanisms often require external power sources to properly function. A car lighter for instance requires the power generated by an automobile alternator or battery to charge. Moreover, prior art car lighters that incorporate coils may lack enough coils to heat properly. Other items used for lighting to very high temperatures, such as a high temperature wood burner or a soldering gun, for instance, require A/C power connected to a typical household outlet. A need therefore exists to create a lighting mechanism connectable to readily available energy sources.

Another problem associated with prior art lighting mechanisms is safety. Other lighting mechanisms known in the prior art have been prone to lighting in an unintended fashion or in an undesirable fashion. A need therefore remains to create a lighter with an improved safety mechanism to prevent unintended lighting.

Often, prior art lighters require some type of liquid fuel to create a flame. This poses a safety hazard. Moreover, fuel can run out, leaving a user in a pinch. Liquid fuel is also difficult to regulate to create a customizable flame with a specific level of heat. For instance, a liquid fuel lighter typically generates a temperature of over 1000 degrees Fahrenheit, much higher than the threshold temperature that creates fumes toxic to the human body in association with the combustion of many substances typically consumed in vapor or gaseous form by humans. A need therefore remains to create a lighter with an alternative source of energy.

### BRIEF DESCRIPTION OF THE FIGURES

FIG. 1 is a perspective view of one embodiment of a fire starting bulb apparatus constructed in accordance with the present disclosure, the fire starting bulb apparatus shown lighting an external object.

FIG. 2 is a front view of another embodiment of a fire starting bulb apparatus.

FIG. 3 is a perspective view of another embodiment of a fire starting bulb apparatus constructed in accordance with the present disclosure.

FIG. 4 is a disassembled cross sectional and perspective view of one embodiment of a fire starting bulb apparatus constructed in accordance with the present disclosure.

FIG. 5 is a cross-sectional view of another embodiment of a fire starting bulb apparatus.

### DETAILED DESCRIPTION OF THE INVENTION

Before explaining at least one embodiment of the inventive concept disclosed herein in detail, it is to be understood that the inventive concept is not limited in its application to the details of construction, experiments, exemplary data, and/or the arrangement of the components set forth in the following description, or illustrated in the drawings. The presently disclosed and claimed inventive concept is capable of other embodiments or of being practiced or carried out in various ways. Also, it is to be understood that the phraseology and terminology employed herein is for purpose of description only and should not be regarded as limiting in any way.

In the following detailed description of embodiments of the inventive concept, numerous specific details are set forth in order to provide a more thorough understanding of the inventive concept. However, it will be apparent to one of ordinary skill in the art that the inventive concept within the disclosure may be practiced without these specific details. In other instances, well-known features have not been described in detail to avoid unnecessarily complicating the instant disclosure.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

At least one embodiment of the present disclosure is directed to an ignition device, with a particular focus on lighting a cigarette or other smoking implement. Alternative embodiments of the invention are intended to light fires for other purposes. Embodiments of the invention create fire by touching or rubbing an intended point of contact onto a targeted flammable material.

Referring now to FIG. 1, shown therein is a fire starting bulb apparatus 10 touching a cigarette 12 so as to light the cigarette 12. However, although a cigarette is shown being used with the fire starting bulb apparatus 10, by way of example, it should be understood that the fire starting bulb apparatus 10 may ignite any external object, as so desired. The apparatus 10 includes a plurality of contact points 14a and 14b capable of being operably connectable to an energy source 15, a heating element 16 and a heating bulb 18 having a heating surface 19.

It is an understood feature of embodiments of the invention to fit within readily available sockets otherwise designed to fit standard sized light bulbs. In the preferred embodiment, the size corresponds with the sizing of a standard LED as known in the prior art. Typically, new very small glass bulbs now utilize LED technology, and that an opportunity to utilize complementary components of such technology exists for deployment of an ignition device as intended herein. A smaller size requires less costly mass, which therefore allows for embodiments to be manufactured at an affordable cost for most consumers. In an embodiment of the invention, the fire starting mechanism is linked to at least one male electronic contact point 14 configured to fit within a female electronic contact point comprising a light bulb receptacle. In an embodiment, the contact point 14 is configured as a base to fit within a standard E5 bulb socket. In alternative embodiments, the contact point 14 is configured to fit within bulb sockets of other standard screw sizes, including E12, E17, E39, E10, E11, E17, E26, E27, E39, E40, and EX39. Alternative embodiments of the invention are configured to fit into a socket other than a standard lightbulb socket. In alternative embodiments, the contact point 14 is configured to fit within bulb sockets of other sizes, including bipost, single contact, can bay, side prong, disc base, or end prong configurations. In an embodiment, the contact point 14 is configured to fit within a Christmas light bulb socket. The energy source 15 is any variety of electrical sources known in the art such as, by way of an example, an outlet, battery, or the like. It should be understood by one of ordinary skill in the art that so long as the fire starting bulb apparatus functions in accordance with the present disclosure, any source for providing energy to an object can be utilized.

The heating element 16 is operably connected to at least one of the contact point(s) 14a and 14b. In one embodiment, the heating element 16 consists of a wood burning tip for a pyrography wood burning pen, capable of performing at an adjustable temperature. It should be understood that the heating element 16 may be any variety of heating elements known in the art so long as the heating element functions in accordance with the present disclosure. A vacuum exists between the heating element 16 and the heating surface 19 of the bulb 18. As the heating element 16 heats up, the heat radiates to the material of the bulb 18 which absorbs the heat and heats the surface 19 so as to light the desired object.

In one embodiment, the heating element is connectably linked via standard electronic components readily recognizable by those skilled in the art to a receptacle attachably linked to a 12-volt battery to provide power. A 12-volt battery produces enough energy to enable the heating element to generate the heat necessary for ignition of objects placed in contact with a heating surface. The portability of a 12-volt battery allows for use of embodiments of the invention in a variety of standard contexts. Embodiments of the invention are adapted to allow for the incorporation of a rechargeable battery, or to allow for charging and/or operation directly from current a car battery in association with various connection mechanisms readily apparent by one skilled in the art.

In one embodiment, the heating bulb 18 is formed as a glass shield of quartz glass. In an alternative embodiment, the heating bulb 18 can be formed from ceramic, borosilicate glass, or the like. In some embodiments, the heating bulb 18 has a rough, non-smooth surface. The surface roughness of the heating bulb 18 aids in the combustion of external objects placed in contact with the heating surface.

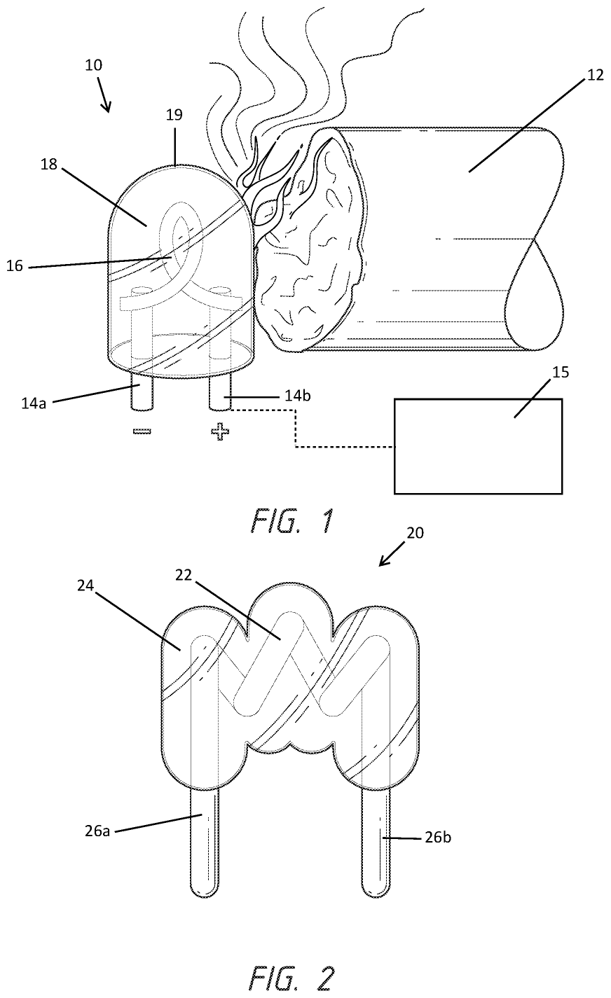

Referring to FIG. 2, shown therein is another embodiment of a fire starting bulb apparatus 20 which is similar to the fire starting bulb apparatus 10. The fire starting bulb apparatus 20 has a heating element 22 which is sized and configured in correlation to a shaped bulb 24. The heating element 22 is shaped to form a plurality of contact points 26a and 26b. It should be understood by one of ordinary skill in the art that the bulb and heating element may be any variety of shape, size and configuration so long as the apparatus 20 functions in accordance with the present disclosure.

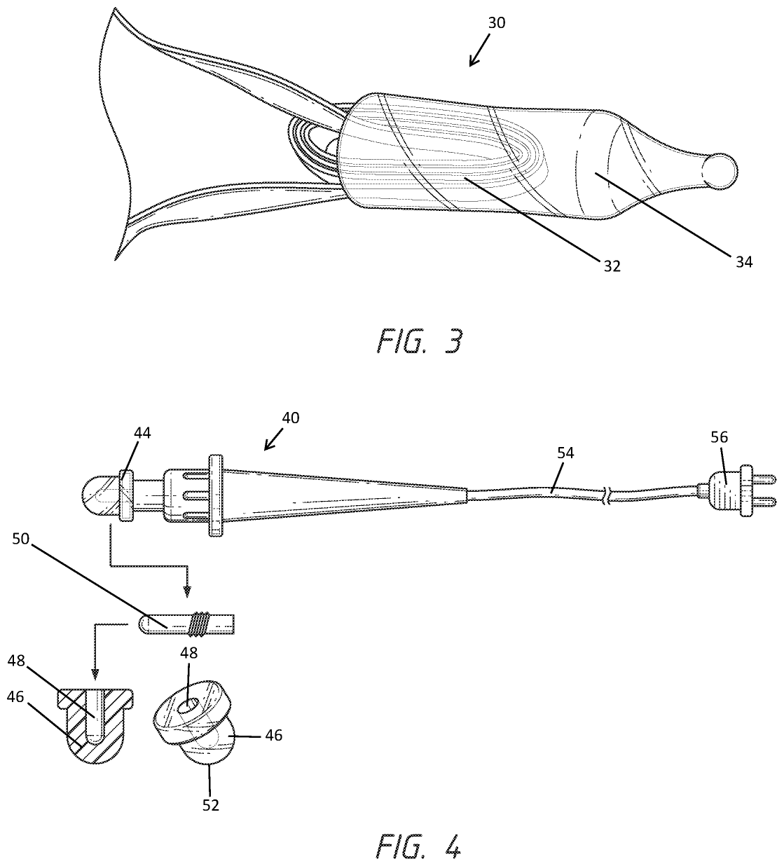

Referring to FIG. 3, in an alternative embodiment, a fire starting bulb apparatus 30 is shown similar to the fire starting bulb apparatus 10 except that the apparatus 30 include a heating element 32 as a coil and a heating bulb 34 sized and configured to receive the coil 32.

Referring now to FIG. 4, a fire starting apparatus 40 is shown having a body 42 for receiving a bulb assembly 44. The bulb assembly 44 includes a bulb 46 provided with a divot 48 for receiving a heating element 50. The heating element 50 is configured to fit within the divot 48 formed into the bulb 46. The bulb 46 is provided with a heating surface 52. The fire starting apparatus 40 is provided with a power cord 54 which is operably connected to the body 42 to provide energy to the bulb assembly 44. The power cord 54 includes a plug 56 for use with an electrical outlet.

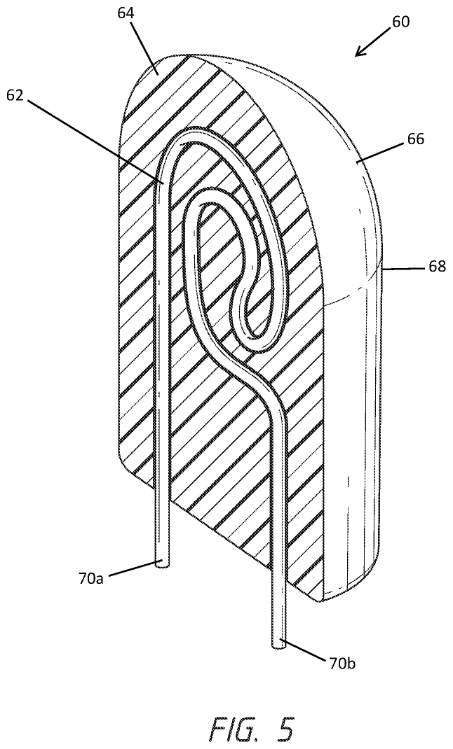

Referring to FIG. 5, a fire starting bulb apparatus 60 is shown constructed in accordance with one embodiment of the present disclosure. The fire starting bulb apparatus 60 is provided with a heating element 62 configured to be directly in contact with an inner surface 64 of a bulb 66. In one embodiment, the heating element 62 is configured to cover a substantially broad area of the inner surface 64 of the bulb so that the outer surface 68 of the bulb 66 is more substantially heated. The heating element 62 is provided with a plurality of contact points 70a and 70b so as to contact the energy source (not shown). One embodiment of the present disclosure provides a heating element directly coated with ceramic. In an embodiment, a ceramic coating is placed directly on the heating element itself forms the heating surface, wherein the heating element directly contacts the ceramic coating creating a solid, unified mass. The ceramic coating renders a metal heating element safer for human-consumable vapors from smoking implements than vapors consumed from uncoated metal-ignited smoking implements.

The electronic nature of the embodiments of the present disclosure allows for the regulation of the temperature generated. One embodiment of the invention incorporates a control mechanism, such as a dial or switch, to control the current and therefore the temperature generated by the embodiment. This is particularly useful given that some substances become toxic and therefore unsuitable for human consumption at certain temperature levels. Specifically, in an embodiment of the present invention, the temperature may be regulated such that it leads to a temperature of no more than 380° F., the temperature by which cannabis-derived vapors become toxic.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The terms “coupled” and “linked” as used herein is defined as connected, although not necessarily directly and not necessarily mechanically. A device or structure that is “configured” in a certain way is configured in at least that way but may also be configured in ways that are not listed. Also, the sequence of steps in a flow diagram or elements in the claims, even when preceded by a letter does not imply or require that sequence.

From the above description, it is clear that the inventive concept(s) disclosed herein is well adapted to carry out the objects and to attain the advantages mentioned herein as well as those inherent in the inventive concept disclosed herein. While exemplary embodiments of the inventive concept disclosed herein have been described for purposes of this disclosure, it will be understood that numerous changes may be made which will readily suggest themselves to those skilled in the art and which are accomplished without departing from the scope of the inventive concept disclosed herein and defined by the appended claims.

What is claimed is:

1. A fire starting bulb apparatus, comprising:
a heating element;
at least one contact point operably connected to the heating element, the at least one contact point configured to connect to an energy source for providing energy to the heating element; and
a bulb having an outer surface, the bulb configured to receive the heating element so that the heating element provides heat to the outer surface of the bulb when the heating element receives energy.

2. The fire starting bulb apparatus of claim 1 wherein the heating element is capable of functioning at an adjustable temperature.

3. The fire starting bulb apparatus of claim 1 wherein the heating element is a wood burning tip.

4. The fire starting bulb apparatus of claim 1 wherein the at least one contact point is a plurality of contact points.

5. The fire starting bulb apparatus of claim 1 wherein the at least one contact point is the same material as the heating element.

6. The fire starting bulb apparatus of claim 1 wherein the energy source is an electrical outlet.

7. The fire starting bulb apparatus of claim 1 wherein a vacuum is provided between the bulb and the heating element.

8. The fire starting bulb apparatus of claim 1 wherein the heating element is in direct contact with the bulb.

9. The fire starting bulb apparatus of claim 1 wherein the heating element is formed in the bulb.

10. The fire starting bulb apparatus of claim 1 wherein the bulb is provided with a divot for receiving the heating element.

11. The fire starting bulb apparatus of claim 1 wherein the heating element is a coil.

12. The fire starting bulb apparatus of claim 1 wherein the heating element is sized and shaped substantially the same as the bulb.

13. The fire starting bulb apparatus of claim 1 wherein the heating element is coated by a ceramic material.

14. The fire starting bulb apparatus of claim 1 wherein the heating element is shaped to form a plurality of contact points.

15. The fire starting bulb apparatus of claim 1 wherein the heating element is metal.

16. A method of using a fire starting bulb apparatus, comprising the steps of:
providing a fire starting bulb apparatus, comprising:
a heating element;
at least one contact point operably connected to the heating element, the at least one contact point configured to connect to an energy source for providing energy to the heating element; and
a bulb having an outer surface, the bulb configured to receive the heating element so that the heating element provides heat to the outer surface of the bulb when the heating element receives energy;
connecting the at least one contact point to the energy source; and
contacting an external object to the outer surface of the bulb to ignite the external object.

17. The method of claim 16 wherein the heating element is capable of functioning at an adjustable temperature.

18. The method of claim 16 wherein a vacuum is provided between the bulb and the heating element.

19. The method of claim 16 wherein the heating element is in direct contact with the bulb.

20. The method of claim 16 wherein the energy source is an electrical outlet.
